(19) United States
(12) Patent Application Publication
(10) Pub. No.: US 2013/0233894 A1
(43) Pub. Date: Sep. 12, 2013

(54) TABLET CASSETTES OF TABLET MEDICINE PACKING APPARATUS

(71) Applicant: Ho Yeon Kim, Anyang-si (KR)

(72) Inventor: Ho Yeon Kim, Anyang-si (KR)

(73) Assignees: Aliarx, Plano, TX (US); Cretem Co., Ltd., Anyang-Si, Gyeonggi-do (KR)

(21) Appl. No.: 13/989,552

(22) PCT Filed: Nov. 24, 2011
(86) PCT No.: PCT/KR2011/009019

§ 371 Date: May 24, 2013

(30) Foreign Application Priority Data
Nov. 26, 2010 (KR) 10-2010-0119161

(51) Int. Cl. G01F 11/10

(52) U.S. Cl. CPC B67C 9/00
USPC 222/370

(57) ABSTRACT

A tablet cassette of tablet medicine packing apparatus is disclosed. The tablet cassette includes a tablet outlet opened such that tablets contained inside thereof to be discharged, a drum opening and closing the tablet outlet selectively, a lever controlling movement of the drum when the cartridge is separated from the cartridge installation unit, wherein the lever includes a drum contacting unit to be pressed elastically in the direction of contacting with the drum, while the drum contacting unit is separated from the drum when the cartridge is mounted on the cartridge installation unit.

### TECHNICAL FIELD

Embodiments relates to a tablet cassette of a tablet medicine packing apparatus, and more particularly, to a tablet cassette installed in a tablet medicine packing apparatus packing tablet medicines such as capsules in each dose automatically, accepting a large volume of tablets, and discharging the tablets according to a prescription.

### BACKGROUND ART

A medicine packing apparatus is an apparatus for discharging tablet medicines prescribed according to the illness of a patient and packing the tablet medicines in each dose automatically. The medicine packing apparatus includes an installation unit on which a plurality of tablet cassettes containing each different kind of tablet are mounted and a hopper disposed below the installation unit. The tablet medicines are discharged from each of the tablet cassettes that are controllable through a bottom open mousth of the table cassettes and then assembled in the hopper. The tablets assembled in the hopper are discharged down the hopper and packed with sealed in a packing paper.

The tablet cassette includes a cartridge and a cartridge installation unit. A cartridge may contain tablets. Meanwhile, tablets should be left in the cartridge may be easily dropped from the cartridge through the bottom open mouth, when the cartridge is separated from the cartridge installation unit, which causes waste of tablets.

### DETAILED DESCRIPTION OF THE INVENTION

### Technical Goal of the Invention

The inventive concept provides a tablet cassette of a tablet medicine packing apparatus improved such that tablets may not be dropped from a cartridge even if the cartridge is separated from a cartridge installation unit.

### Technical Solution of the Invention

According to an exemplary embodiment of the inventive concept, a tablet cassette of a tablet medicine packing apparatus includes a cartridge and a cartridge installation unit. The cartridge contains tablets. The cartridge is mounted on the cartridge installation unit. The cartridge includes a tablet outlet, a drum, and a lever. The tablet outlet is opened such that the tablets contained inside the cartridge may be discharged. The drum opens and shuts the tablet outlet selectively. The lever controls movement of the drum when the cartridge is separated from the cartridge installation unit. The lever includes a drum contacting unit. The drum contacting unit receives elastic pressing power in a direction of the contacting with the drum, but it is separated from the drum when the cartridge is mounted on the cartridge installation unit.

The lever may further include a trigger. At the same time, the cartridge installation unit may include a protrusion protruding so as to contact with the trigger when the cartridge is mounted on the cartridge installation unit. Accordingly, the trigger may be pushed by the protrusion in the direction of the drum contacting unit being separated from the drum, when the trigger contacts with the protrusion.

The cartridge may include a trigger space. The trigger diversion is prepared such that the trigger may be pushed when the trigger contacts with the protrusion.

Also, an array wall protrudes downward from the perimeter of the cartridge bottom, and the protrusion protrudes so as to be inserted to the inside of the cartridge by sliding by the upper side of the cartridge installation unit and the inner side of the array wall.

Also, a lever pivot is formed on the bottom of the cartridge, the lever is combined with the lever shaft so as to pivot, and a torsion spring giving elastic pressing power to the lever in the direction of the drum contacting unit contacting with the drum may be interposed to the lever pivot.

Meanwhile, the drum may include projections protruded on the outer circumference surface by certain intervals, and guide grooves extended downward between the two adjacent projections so as to passing through the tablets therethrough. At this time, the tablet outlet of the cartridge may be locked with the projection by contacting the drum contacting unit of the lever with the projection of the outer circumference surface.

The drum contacting unit may include a method for increasing friction with the drum surface.

### Effect of the Invention

A tablet cassette of a tablet medicine packing apparatus of the present inventive concept prevents tablets from being dropped outside of the cartridge by fixing a drum inside cartridge when the cartridge is separated from the cartridge installation unit, thereafter, restraining waste of tablets.

### BRIEF DESCRIPTION OF THE DRAWINGS

Exemplary embodiments of the inventive concept will be more clearly understood from the following detailed description taken in conjunction with the accompanying drawings in which:

FIG. 1 is an exploded perspective view of a tablet cassette of a tablet medicine packing apparatus according to an exemplary embodiment of the inventive concept;

FIG. 2 is a perspective view of a part of the tablet cassette shown in FIG. 1, which shows loading a cartridge on a cartridge installation unit; and

FIGS. 3 and 4 illustrate the bottom of the cartridge of the tablet cassette, wherein FIG. 3 is a diagram when the cartridge is mounted on the cartridge installation unit and FIG. 4 is a diagram when the cartridge is separated from the cartridge installation unit.

### BEST MODE FOR CARRYING OUT THE INVENTION

Various example embodiments will be described more fully hereinafter with reference to the accompanying drawings, in which some example embodiments are shown. Inventive concepts may, however, be embodied in many different forms and should not be construed as limited to the example embodiments set forth herein. Rather, example embodiments are provided so that this disclosure will be thorough and complete, and will fully convey the scope of inventive concepts to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the inventive concepts. As used herein, the term “and/or” includes any and all combinations of one or more of the associated listed items.

It will be understood that when an element is referred to as being “connected” or “paired” to another element, it can be directly connected or paired to the other element or intervening elements may be present. In contrast, when an element is referred to as being “directly connected” or “directly paired” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the inventive concepts. As used herein, the singular forms “a,” “an” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which inventive concepts belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A plurality of tablet cassettes according to an exemplary embodiment of the inventive concept are disposed on the upper body of a tablet medicine packing apparatus (not shown). Each of the tablet cassettes contains different of same kind of tablets. A hopper is prepared beneath the tablet cassettes, where tablet medicines discharged from the tablet cassettes are assembled. A packing unit for packing tablets discharged through the hopper in packing paper is prepared below the hopper.

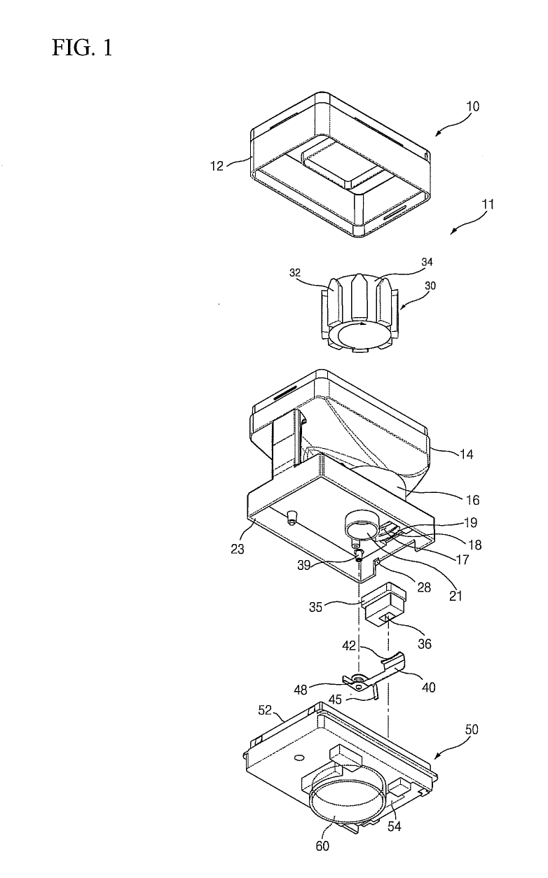

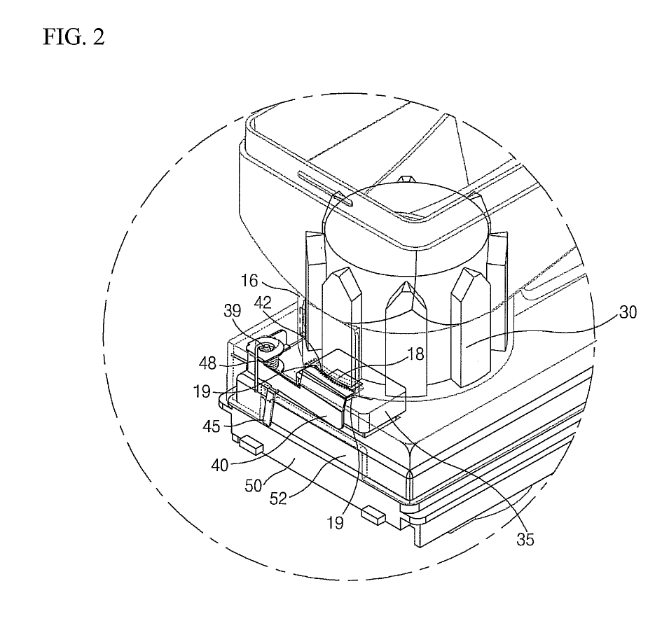

FIG. 1 is an exploded perspective view of the tablet cassette of the tablet medicine packing apparatus according to an exemplary embodiment of the inventive concept, and FIG. 2 is a perspective view of a part of the tablet cassette shown in FIG. 1, which shows the form of the cartridge being loaded on the cartridge installation unit.

Referring to FIG. 1, the tablet cassette 10 of a tablet medicine packing apparatus according to an exemplary embodiment of the inventive concept includes a cartridge 11 and a cartridge installation unit 50.

The cartridge 11 contains tablet medicines. The cartridge 11 is installed on the cartridge installation unit 50 detachably. The cartridge 11 includes an upper housing 12, a lower housing 14, a drum 30, and a tablet guide block 35.

The interior space containing tablets is formed by combining the upper housing 12 and the lower housing 14. A tablet output 17 is formed on the bottom of the lower housing 14. Tablets contained inside the cartridge 11 may be discharged to the outside through the tablet outlet 17.

The drum 30 is located in the interior space of the cartridge 11. At this time, a throat 16 is formed on the tablet outlet 17 of the cartridge 11, and the drum 30 which is rotatable is inserted therein.

The drum 30 includes projections 32 on the outer circumference surface by certain intervals, and guide grooves 34 extended below are formed between adjacent pairs of projections 32. Tablets received inside the throat 16 flow into each guide groove 34 in a row by self-weight. Accordingly, whenever the drum 30 rotates by the angle between the adjacent two projections 32 at a predetermined speed, a tablet (or the required amount of tablets) is discharged outside through the tablet outlet 17.

The cartridge 11 is mounted on the cartridge installation unit 50. At this time, a motor 60 providing rotation driving power to the drum 30 is installed on the cartridge installation unit 50, and a motor connection through hole 21 is formed on the bottom of the lower housing 14 of the cartridge 11 such that a pivot (not shown) of the motor 60 may be inserted. The pivot of the motor 60 is connected to the drum 30 through the motor connection through hole 21 so as to transfer power, when the cartridge 11 is mounted on the cartridge installation unit 50.

An array wall 23 protruding below is formed on the perimeter of the bottom of the lower housing 14, and protrusions 52 are formed on the upper side of the cartridge installation unit 50, such that the cartridge 11 can be installed in the accurate position arranged when being mounted on the cartridge installation unit 50.

The protrusions 52 are inserted into the space of the bottom of the lower housing 14 which is formed by the array wall 23 by sliding by the inner surface of the array wall 23.

The tablet guide block 35 is combined beneath the tablet outlet 17. A tablet discharge path 36 is formed in the tablet guide block 35. The tablet guide block 35 is inserted to a block containing through hole 54 when the cartridge 11 is installed on the cartridge installation unit 50.

Accordingly, when the drum (30) rotates, a tablet flows into the tablet outlet 17 of the lower housing 14, then, is discharged below the tablet cassette 10 through the tablet discharge path 36 of the tablet guide block 35, and assembles in a hopper (not shown).

Referring to FIGS. 1 and 2, a lever 40 is installed in the cartridge 11 of the tablet cassette 10. The lever 40 is combined to a lever pivot 39 formed on the bottom of the lower housing 14 so as to be pivotable. The lever controls movement of the drum 30 when the cartridge 11 is separated from the cartridge installation unit 50. The lever 40 includes a drum contacting unit 42 and a trigger 45. The drum contacting unit 42 is formed at the end of the lever 40. The trigger 45 protrudes below between the lever axis 39 and the drum contacting unit 42. The lever 40 may be formed by a press forming of a metal plate or a mold forming of.

A torsion spring 48 is interposed in the lever pivot 39. The torsion spring 48 presses the drum contacting unit 42 to contact the drum 30 with elastic power.

The lever 40 is combined to the bottom of the lower housing 14, And the drum 30 is located inside the throat 16 of the lower housing 14. Accordingly, a first long hole 18 through which the drum contacting unit 42 passes is prepared in the throat 16 such that the drum contacting unit 42 may contact with the drum 30. Also, a second long hole 19 is prepared beside the tablet outlet 17 such that the lever 40 may be pivotable. The drum contacting unit 42 includes a terminal surface of sawtoothed shape. The sawtoothed shape is for increasing friction between the drum contacting unit 42 and the surface of the drum 30. However, other methods for increasing friction not shown, for example, applying a resin having a high friction coefficient, may be applied.

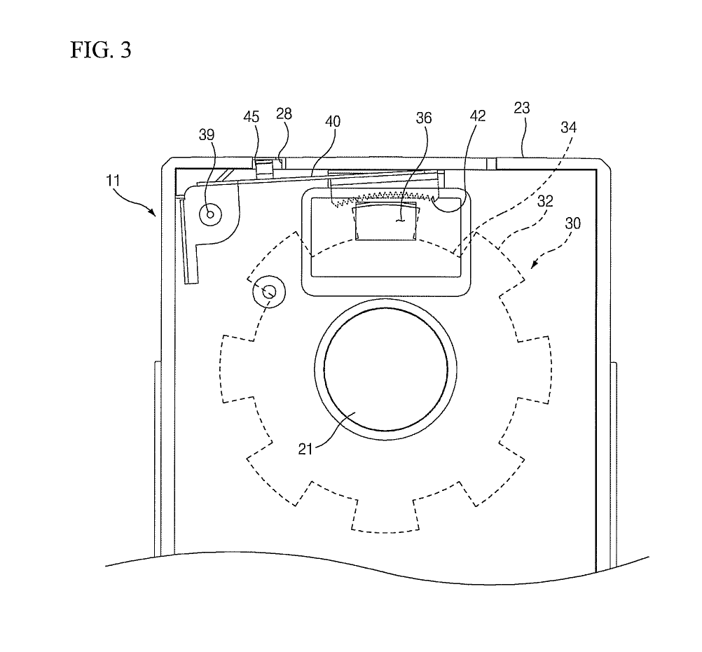

The trigger 45 is designed to be pushed in the outside direction by being contacted with the protrusion 52 that is formed on the upper surface of the cartridge installation unit 50, when the cartridge 11 is mounted on the cartridge installation unit 50. Accordingly, the lever 40 may rotate in the direction that the drum contacting unit 42 is separated from the drum 30 on the pivot 39 (referring to FIG. 3) when the cartridge 11 is mounted on the cartridge installation unit 50.

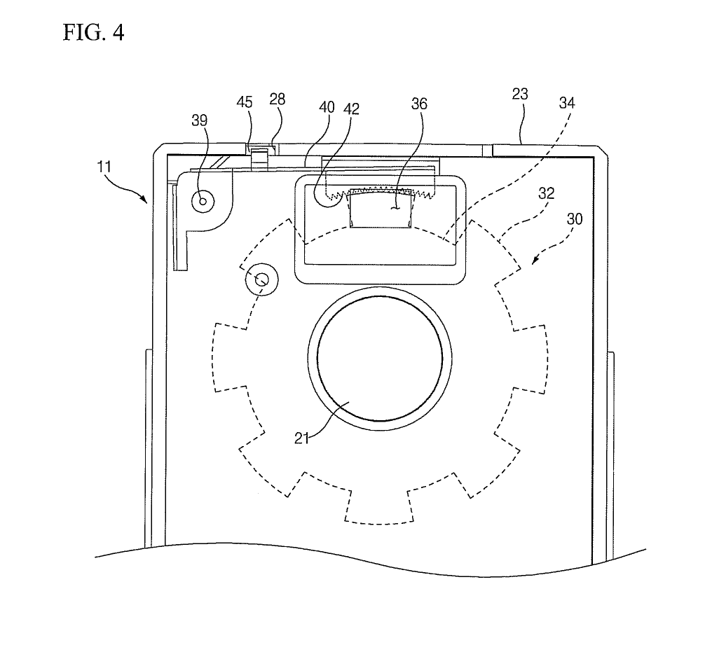

On the contrary, the trigger 45 is separated from the protrusion 52 when the cartridge 11 is separated from the cartridge installation unit 50, accordingly, the lever 40 rotates in the opposite direction on the pivot 39, thereby the drum contacting unit 42 contacting the outer circumference surface of the drum 30 (referring to FIG. 4).

A trigger space 28 is prepared on the lower housing 14 of the cartridge 11 such that the trigger 45 may be pushed in the outside direction enough when the trigger 45 contacts with the protrusion 52. According to an exemplary embodiment, the trigger space 28 is prepared on one side of the array wall 23, but the embodiment is not restricted thereto. The lever 40 rotates such that the drum contacting unit 42 is separated from the outer circumference surface enough by the trigger division 28, when the cartridge 11 is mounted on the cartridge installation unit 50. At this state, the torsion spring 48 presses the outer circumference surface of the drum 30 with elastic power, therefore, the drum 30 may not rotate randomly due to friction between the drum contacting unit 42 and the outer circumference surface of the drum 30, even though mechanical connection between the drum 30 and the motor 60 is released.

Also, FIGS. 3 and 4 illustrate the bottom of a cartridge of tablet cassette, FIG. 3 illustrates the form of a cartridge being loaded on a cartridge installation unit, and FIG. 4 illustrates the form of the cartridge being separated from the cartridge installation unit. Referring to FIGS. 3 and 4, the operation of the lever 40 will be described again. Referring to FIGS. 1 and 3 together, the trigger 45 of the lever 40 is pushed outside by the protrusion 52 when the cartridge 11 is mounted on the cartridge installation unit 50, thereby the drum contacting unit 42 being separated from the projection 32 of the drum 30. At this state, the pivot (not shown) of the motor 60 is inserted into the motor connection through hole 21 to be connected to the drum 30 mechanically, thus, the drum 30 is controlled by driving power of the motor 60. One tablet may be discharged through the tablet discharge outlet 36 while the drum 30 rotates from the location of the projection 32 blocking the tablet discharge outlet 36 to the location of the adjacent projection 32 blocking the tablet discharge outlet 36.

Referring to FIGS. 1 and 4 together, the lever 40 rotates by elastic restoration power of the torsion spring 48 for the drum contacting unit 42 to press the projection 32 of the drum 30 when the cartridge 11 is separated from the cartridge installation unit 50. Accordingly, the drum 30 may not rotate randomly due to friction with drum contacting unit 42 even though the drum 30 is separated from the motor 60 mechanically, therefore, the projection 32 blocks the tablet discharge outlet 36 to prevent unintended dropping of tablets contained in the cartridge 11.

While the present invention has been particularly shown and described with reference to exemplary embodiments thereof, it will be understood that various changes in form and details may be made therein without departing from the spirit and scope of the following claims.

### INDUSTRIAL USABILITY

The present invention is applicable to a tablet medicine packing apparatus packing tablet medicines by a dose automatically at hospitals, pharmacies, home, or the like.

1. A cassette of a tablet medicine packing apparatus including a cartridge containing tablets inside and a cartridge installation unit on which the cartridge is mounted comprising:
a tablet outlet opened such that tablets contained inside thereof may be discharged;
a drum opening and closing the tablet outlet selectively; and
a lever controlling movement of the drum when the cartridge is separated from the cartridge installation unit, wherein the lever includes a drum contacting unit designed to be separated from the drum when the cartridge is separated from the cartridge installation unit.

2. The cassette of claim 1, wherein the lever further includes a trigger, the cartridge installation unit includes a protrusion part protruding so as to contact with the trigger when the cartridge is mounted on the cartridge installation unit, and the trigger is designed to be pushed in the direction that the drum contacting unit of the lever is separated from the drum when the trigger contacts with the protrusion part.

3. The cassette of claim 2, wherein the cartridge includes a trigger space prepared such that the trigger may be pushed when the trigger contacts with the protrusion part.

4. The cassette of claim 2, wherein the cartridge includes array wall around the perimeter of the bottom of the cartridge, and the protrusion part is formed to be inserted inside of the cartridge by sliding by the inner surface of the array wall.

5. The cassette of claim 2, wherein the bottom of the cartridge includes a lever pivot;
the lever is combined to the lever pivot pivotably; and
a torsion spring pressing the lever elastically in the direction that the drum contacting unit contacts with the drum is interposed to the lever pivot.

6. The cassette of claim 1, wherein the drum contacting unit includes a method for increasing friction with the drum surface.

7. The cassette of claim 1, wherein the drum comprising:
projections protruding on the outer circumference surface at certain intervals; and
guide grooves extending below between a pair of adjacent projections for guiding tablets to be discharged below, and
wherein the drum contacting unit of the lever fixes the cartridge by contacting the drum contacting unit with the projection on the outer circumference surface of the drum, thereby the projection blocking the tablet outlet.
